(19) United States
(12) Patent Application Publication
(10) Pub. No.: US 2026/0175426 A1
(43) Pub. Date: Jun. 25, 2026

(54) METHOD AND APPARATUS FOR GENERATING ROBOTIC NAVIGATION MAP FROM NOISY INDOOR POINT CLOUDS

(71) Applicant: LG ELECTRONICS INC., Seoul (KR)

(72) Inventors: Kyle Xingkai BAO, Glenview, IL (US); Eric HWANG, Vernon Hills, IL (US); Enda Mcgrath, Park Ridge, IL (US)

(73) Assignee: LG ELECTRONICS INC., Seoul (KR)

(21) Appl. No.: 19/391,888

(22) Filed: Nov. 17, 2025

Related U.S. Application Data
(60) Provisional application No. 63/738,549, filed on Dec. 24, 2024.

(51) Int. Cl. B25J 9/16; B25J 19/02; G05D 1/246

(52) U.S. Cl. CPC B25J 9/1664; B25J 9/161; B25J 9/163; B25J 19/023; G05D 1/2465

(57) ABSTRACT

According to at least one embodiment, a method of generating a global 2D map of an indoor environment includes: processing a 3D point cloud of the indoor environment; detecting one or more clusters of points that are present in the 3D point cloud; in response to the detecting, removing the cluster(s) from the 3D point cloud to produce a global 3D point cloud, based on determining that an object corresponding to the detected cluster(s) is unwanted; and dividing the global 3D point cloud into 3D segments. The method further includes for each of the 3D segments: identifying a local floor as a reference plane of the 3D segment; and collecting a 2D slice of the 3D segment at a height of the 2D sensor of the robot with respect to the identified local floor. The collected 2D slices of the 3D segments are assembled to form the global 2D map.

### CROSS-REFERENCE TO RELATED APPLICATIONS

Pursuant to 35 U.S.C. § 119, this application claims the benefit of earlier filing date and right of priority to Provisional Application No. 63/738,549, filed on Dec. 24, 2024, the contents of which are all incorporated by reference herein in its entirety.

### BACKGROUND

A robot may refer to a machine that automatically processes or operates a given task by its own ability. In particular, a robot having a function of recognizing an environment and performing a self-determination operation may be referred to as an intelligent robot. Robots may be classified into various categories including industrial robots, medical robots, home robots, military robots, and the like according to the use purpose or field.

A driving unit of a robot may include an actuator or a motor and may perform various physical operations such as moving a robot joint. In addition, a movable robot may include a wheel, a brake, a propeller, and the like in a driving unit, and may travel on the ground or fly in the air.

Indoor robotic navigation is typically performed using two-dimensional (2D) or three-dimensional (3D) maps. Such maps can be used to guide robotic navigation for a variety of applications, including but not limited to autonomous vacuum cleaning, food and service delivery, tourist assistance, and automated roaming tasks.

3D maps can be generated using red-green-blue-depth (RGB-D) cameras in conjunction with simultaneous localization and mapping (SLAM) algorithms. The map data may include object identification information about various objects disposed in the space in which the robot moves. For example, the map data may include object identification information about fixed objects such as walls and doors and movable objects such as furniture and desks. The object identification information may include a name, a type, a distance, and a position of a given object.

The robot may use at least one of the map data, object information detected by one of its sensors, or object information acquired from an external source to determine a travel route and a travel plan, and may control the driving unit such that the robot travels along the determined travel route and travel plan.

### SUMMARY

The 3D maps are usable by robots equipped with 3D sensors such as 3D LiDAR sensors. However, not all robots are equipped with such sensors. For example, some robots (e.g., robots that are less expensive) may be equipped with 2D sensors such as 2D LiDAR sensors that are typically less costly. Such robots rely on 2D maps for navigating indoor environments such as offices, restaurants, hotels, and airports.

When 2D maps are produced from 3D maps that are based on 3D point clouds, the point clouds may contain significant noise and unwanted objects. Common intrusions may include pedestrians, furniture (e.g., chairs), cleaning equipment, garbage, and toys, all of which can negatively affect accuracy of resulting 2D maps and robot navigation performance.

Aspects of this disclosure are directed to a method and apparatus for generating 2D navigation maps for robotics applications from noisy indoor point clouds. According to one or more aspects, deep learning-based classification techniques are used to perform both 3D and 2D object detection. Unwanted objects are autonomously identified and filtered from the navigation maps, resulting in cleaner and more reliable 2D maps suitable for robotic navigation.

By way of example, sensor noise is filtered and unwanted 3D objects within point clouds are detected by using semi-supervised convolutional neural networks (CNNs) for deep learning-based classification. A clean and accurate 2D navigation map for use by a given robot is generated by slicing the 3D point cloud at a height of a sensor of the robot above the floor. Unwanted 2D obstacles are further filtered based on the distinctive features of their 2D contours, allowing for precise outline-based rejection of non-structural elements.

According to at least one embodiment, a computer-implemented method of generating a global two-dimensional (2D) map of an indoor environment based on three-dimensional (3D) data is disclosed. The 2D map is for guiding autonomous navigation of a robot including a 2D sensor. The computer-implemented method includes: processing a 3D point cloud of the indoor environment; detecting one or more clusters of points that are present in the processed 3D point cloud; in response to the detecting, removing the one or more clusters from the processed 3D point cloud to produce a global 3D point cloud, based on determining that an object corresponding to the detected one or more clusters is unwanted; and dividing the global 3D point cloud into a plurality of 3D segments, each of the segments corresponding to a respective spatial portion of the indoor environment. The method further includes for each of the plurality of 3D segments: identifying a local floor as a reference plane of the 3D segment; and collecting a 2D slice of the 3D segment at a height of the 2D sensor of the robot with respect to the identified local floor. The method further includes: assembling the collected 2D slices of the plurality of 3D segments to form the global 2D map.

According to at least one embodiment, an artificial intelligence (AI) device is configured to generate a global two-dimensional (2D) map of an indoor environment based on three-dimensional (3D) data. The 2D map is for guiding autonomous navigation of a robot including a 2D sensor. The AI device includes: at least one transceiver; and at least one processor configured to: process a 3D point cloud of the indoor environment; detect one or more clusters of points that are present in the processed 3D point cloud; in response to the detecting, remove the one or more clusters from the processed 3D point cloud to produce a global 3D point cloud, based on determining that an object corresponding to the detected one or more clusters is unwanted; and divide the global 3D point cloud into a plurality of 3D segments, each of the segments corresponding to a respective spatial portion of the indoor environment. The at least one processor is further configured to, for each of the plurality of 3D segments: identify a local floor as a reference plane of the 3D segment; and collect a 2D slice of the 3D segment at a height of the 2D sensor of the robot with respect to the identified local floor. The at least one processor is further configured to: assemble the collected 2D slices of the plurality of 3D segments to form the global 2D map.

According to at least one embodiment, a non-transitory storage medium stores instructions that, when executed, cause at least one processor to perform operations. The operations include: processing a three-dimensional (3D) point cloud of an indoor environment; detecting one or more clusters of points that are present in the processed 3D point cloud; in response to the detecting, removing the one or more clusters from the processed 3D point cloud to produce a global 3D point cloud, based on determining that an object corresponding to the detected one or more clusters is unwanted; and dividing the global 3D point cloud into a plurality of 3D segments, each of the segments corresponding to a respective spatial portion of the indoor environment. The operations further include for each of the plurality of 3D segments: identifying a local floor as a reference plane of the 3D segment; and collecting a two-dimensional (2D) slice of the 3D segment at a height of a 2D sensor of a robot with respect to the identified local floor. The operations further include: assembling the collected 2D slices of the plurality of 3D segments to form a global 2D map for guiding autonomous navigation of the robot.

### BRIEF DESCRIPTION OF THE DRAWINGS

The accompanying drawings, which are included to provide a further understanding of the disclosure, illustrate embodiments of the disclosure and together with the description serve to explain aspects of the disclosure:

FIG. 1 is a block diagram of an artificial intelligence (AI) device according to at least one embodiment of the present disclosure;

FIG. 2 illustrates a block diagram of an AI server according to at least one embodiment of the present disclosure;

FIG. 3 illustrates an AI system according to at least one embodiment of the present disclosure;

FIG. 4 illustrates a perspective view of a robot according to at least one embodiment;

FIG. 5 is a block diagram of a control module of a robot according to at least one embodiment;

FIGS. 6A and 6B illustrate a flowchart for generating a global 2D map of an indoor environment based on 3D data according to at least one embodiment;

FIG. 7 illustrates an environmental diagram of a robot while in operation in an indoor environment; and

FIGS. 8A and 8B illustrate a flowchart of a method of generating a global 2D map of an indoor environment based on 3D data according to at least one embodiment.

### DETAILED DESCRIPTION

Hereinafter, specific embodiments of the present invention will be described in more detail with reference to drawings.

When it is described that an element is “fastened” or “connected” to another element, it may mean that the two elements are directly fastened or connected, or that a third element exists between the two elements and that the two elements are fastened or connected to each other by said third element. On the other hand, when it is described that an element is “directly fastened” or “directly connected” to another element, it may be understood that no third element exists between the two elements.

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

A self-driving vehicle may be regarded as a robot having a self-driving function.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The ANN may include an input layer, an output layer, and optionally one or more hidden layers. Each layer includes one or more neurons, and the ANN may include a synapse that links neurons to neurons. In the ANN, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the ANN may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an ANN in a state in which a label for learning data is given, and the label may mean the correct answer (or result value) that the ANN must infer when the learning data is input to the ANN. The unsupervised learning may refer to a method of learning an ANN in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among ANNs, is also referred to as deep learning, and the deep learning is part of machine learning. In the following, machine learning is used to mean deep learning.

FIG. 1 is a block diagram of an AI device 10 according to at least one embodiment of the present disclosure. As described below, the AI device 10 may be (or may include) a robot.

The AI device 10 may be stationary or mobile. For example, the AI device may be (or may include) a TV, a projector, a mobile phone, a smartphone, a desktop computer, a notebook, a digital broadcasting terminal, a personal digital assistant (PDA), a portable multimedia player (PMP), a navigation device, a tablet personal computer (PC), a wearable device, a set-top box (STB), a DMB receiver, a radio, a washing machine, a refrigerator, a desktop computer, a digital signage, a robot, a vehicle, and the like.

The AI device 10 may include a communication interface 11, an input interface 12, a learning processor 13, a sensor 14, an output interface 15, a memory 17, and a processor 18.

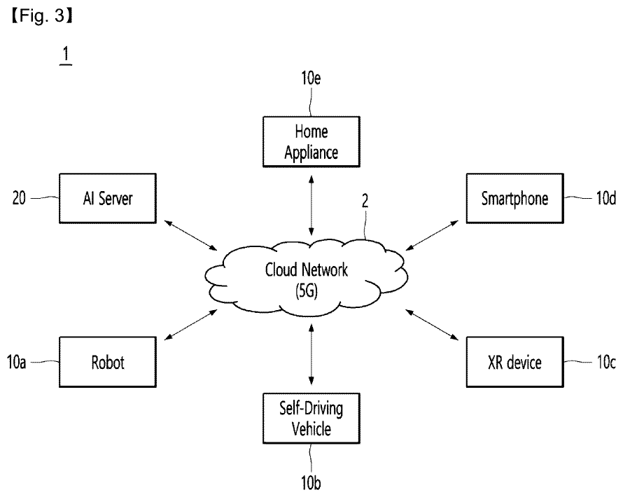

The communication interface 11 may transmit and receive data to and from external devices such as other AI devices 10a, 10b, 10c, 10d, 10e and an AI server 20 by using wired/wireless communication technology (see, e.g., FIG. 3). For example, the communication interface 11 may transmit and receive sensor information, a user input, a learning model, and a control signal to and from external devices.

The communication technology used by the communication interface 11 includes Global System for Mobile communication (GSM), Code Division Multi Access (CDMA), Long Term Evolution (LTE), 5G, Wireless LAN (WLAN), Wi-Fi, Bluetooth, Radio Frequency Identification (RFID), Infrared Data Association (IrDA), ZigBee, Near Field Communication (NFC), and the like.

The input interface 12 may acquire various kinds of data.

For example, the input interface 12 may include a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 12 may acquire a learning data for model learning and an input data to be used when an output is acquired by using the learning model. The input interface 12 may acquire raw input data. In this case, the processor 18 or the learning processor 13 may extract an input feature by preprocessing the input data.

The learning processor 13 may learn a model composed of an ANN by using learning data. The learned ANN may be referred to as a learning model. The learning model may be used to infer a result value for new input data rather than learning data, and the inferred value may be used as a basis for determination to perform a certain operation.

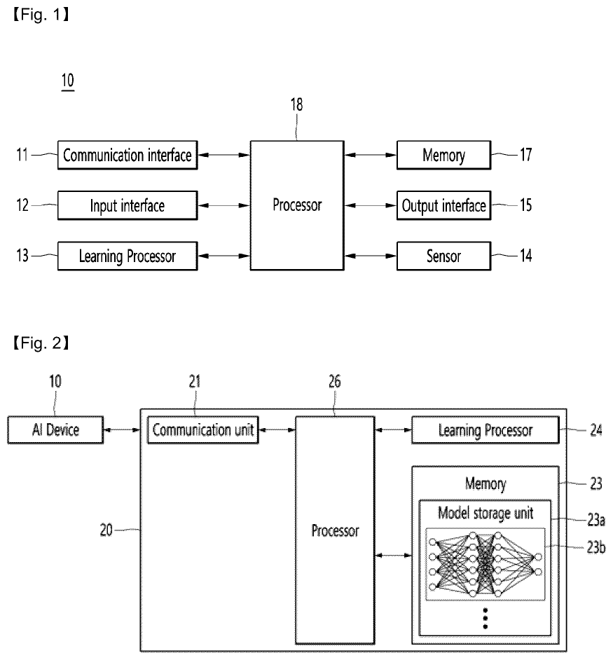

The learning processor 13 may perform AI processing together with a learning processor 24 of the AI server 20 (see, e.g., FIG. 2).

The learning processor 13 may include a memory integrated or implemented in the AI device 10. Alternatively, the learning processor 13 may be implemented by using the memory 17, an external memory directly connected to the AI device 10, or a memory held in an external device.

The sensor 14 may acquire at least one of internal information about the AI device 10, ambient environment information about the AI device 10, or user information by using various sensors.

Examples of the sensors included in the sensor 14 may include a proximity sensor, an illuminance sensor, an acceleration sensor, a magnetic sensor, a gyro sensor, an inertial sensor, a red-green-blue (RGB) sensor, an infrared (IR) sensor, a fingerprint recognition sensor, an ultrasonic sensor, an optical sensor, a microphone, a lidar, and a radar.

The output interface 15 may generate an output related to a visual sense, an auditory sense, or a haptic sense.

The output interface 15 may include a display unit for outputting time information, a speaker for outputting auditory information, and a haptic module for outputting haptic information.

The memory 17 may store data that supports various functions of the AI device 10. For example, the memory 17 may store input data acquired by the input interface 12, learning data, a learning model, a learning history, and the like.

The processor 18 may determine at least one executable operation of the AI device 10 based on information determined or generated by using a data analysis algorithm or a machine learning algorithm. The processor 18 may control components of the AI device 10 to execute the determined operation.

The processor 18 may request, search, receive, or utilize data of the learning processor 13 or the memory 17. The processor 18 may control components of the AI device 10 to execute the predicted operation or the operation determined to be desirable among the at least one executable operation.

When the connection of an external device is required to perform the determined operation, the processor 18 may generate a control signal for controlling the external device and may transmit the generated control signal to the external device.

The processor 18 may acquire intention information for the user input and may determine the user's requirements based on the acquired intention information.

The processor 18 may collect history information including the operation contents of the AI device 10 or the user's feedback on the operation and may store the collected history information in the memory 17 or the learning processor 13 or transmit the collected history information to the external device such as the AI server 20. The collected history information may be used to update the learning model.

The processor 18 may control at least part of the components of AI device 10 so as to drive an application program stored in the memory 17. Furthermore, the processor 18 may operate two or more of the components included in the AI device 10 in combination so as to drive the application program.

FIG. 2 illustrates a block diagram of an AI server 20 according to at least one embodiment of the present disclosure. As illustrated in FIG. 2, the AI server 20 is connected to the AI device 10.

The AI server 20 may refer to a device that learns an ANN by using a machine learning algorithm or uses a learned artificial neural network. The AI server 20 may include a plurality of servers to perform distributed processing, or may be defined as a 5G network. The AI server 20 may be included as a partial configuration of the AI device 10, and may perform at least part of the AI processing together.

The AI server 20 may include a communication interface 21, a memory 23, a learning processor 24, a processor 26, and the like.

The communication interface 21 can transmit and receive data to and from an external device such as the AI device 10.

The memory 23 may include a model storage unit 23a. The model storage unit 23a may store a learning or learned model (or an ANN 26b) through the learning processor 24.

The learning processor 24 may learn the ANN 26b by using the learning data. The learning model may be used in a state of being mounted on the AI server 20, or may be used in a state of being mounted on an external device such as the AI device 10.

The learning model may be implemented in hardware, software, or a combination of hardware and software. If all or part of the learning models are implemented in software, one or more instructions that constitute the learning model may be stored in memory 23.

The processor 26 may infer the result value for new input data by using the learning model and may generate a response or a control command based on the inferred result value.

FIG. 3 illustrates an AI system 1 according to at least one embodiment of the present disclosure

In the AI system 1, at least one of an AI server 20, a robot 10a, a self-driving vehicle 10b, an XR device 10c, a smartphone 10d, or a home appliance 10e is connected to a cloud network 2. The robot 10a, the self-driving vehicle 10b, the XR device 10c, the smartphone 10d, or the home appliance 10e, to which the AI technology is applied, may be referred to as AI devices 10a to 10e, collectively.

The cloud network 2 may refer to a network that forms part of a cloud computing infrastructure or exists in a cloud computing infrastructure. The cloud network 2 may be configured by using a 3G network, a 4G or LTE network, or a 5G network.

That is, the devices 10a to 10e and the server 20 configuring the AI system 1 may be connected to each other through the cloud network 2. In particular, each of the devices 10a to 10e and the server 20 may communicate with each other through a base station, but may directly communicate with each other without using a base station.

The AI server 20 may include a server that performs AI processing and a server that performs operations on big data.

The AI server 20 may be connected to at least one of the AI devices constituting the AI system 1, that is, the robot 10a, the self-driving vehicle 10b, the XR device 10c, the smartphone 10d, or the home appliance 10e through the cloud network 2, and may assist at least part of AI processing of the connected AI devices 10a to 10e.

For example, the AI server 20 may learn the ANN according to the machine learning algorithm instead of the AI devices 10a to 10e, and may directly store the learning model or transmit the learning model to the AI devices 10a to 10e.

The AI server 20 may receive input data from the AI devices 10a to 10e, may infer the result value for the received input data by using the learning model, may generate a response or a control command based on the inferred result value, and may transmit the response or the control command to the AI devices 10a to 10e.

Alternatively, the AI devices 10a to 10e may infer the result value for the input data by directly using the learning model, and may generate the response or the control command based on the inference result.

Hereinafter, various embodiments of the AI devices 10a to 10e to which the above-described technology is applied will be described in more detail. The AI devices 10a to 10e of FIG. 3 may be regarded as specific embodiments of the AI device 10 of FIG. 1.

The robot 10a, to which the AI technology is applied, may be implemented as a guide robot, a carrying robot, a cleaning robot, a wearable robot, an entertainment robot, a pet robot, an unmanned flying robot, or the like.

The robot 10a may include a robot control module for controlling the operation, and the robot control module may refer to a software module or a chip implementing the software module by hardware.

The robot 10a may acquire state information about the robot 10a by using sensor information acquired from various kinds of sensors, may detect (recognize) surrounding environment and objects, may generate map data, may determine the route and the travel plan, may determine the response to user interaction, or may determine the operation.

The robot 10a may use the sensor information acquired from at least one sensor among the lidar, the radar, and the camera so as to determine the travel route and the travel plan.

The robot 10a may perform the above-described operations by using the learning model composed of at least one ANN. For example, the robot 10a may recognize the surrounding environment and the objects by using the learning model, and may determine the operation by using the recognized surrounding information or object information. The learning model may be learned directly from the robot 10a or may be learned from an external device such as the AI server 20.

The robot 10a may perform the operation by generating the result by directly using the learning model, but the sensor information may be transmitted to the external device such as the AI server 20 and the generated result may be received to perform the operation.

The robot 10a may use at least one of the map data, the object information detected from the sensor information, or the object information acquired from the external apparatus to determine the travel route and the travel plan, and may control the driving unit such that the robot 10a travels along the determined travel route and travel plan.

In addition, the robot 10a may perform the operation or travel by controlling the driving unit based on the control/interaction of the user. The robot 10a may acquire the intention information of the interaction due to the user's operation or speech utterance, and may determine the response based on the acquired intention information, and may perform the operation.

The robot 10a, to which the AI technology and the self-driving technology are applied, may be implemented as a guide robot, a carrying robot, a cleaning robot, a wearable robot, an entertainment robot, a pet robot, an unmanned flying robot, or the like.

The robot 10a, to which the AI technology and the self-driving technology are applied, may refer to the robot itself having the self-driving function or the robot 10a interacting with the self-driving vehicle 10b.

The robot 10a having the self-driving function may collectively refer to a device that moves for itself along the given movement line without the user's control or moves for itself by determining the movement line by itself.

The robot 10a may be a guide robot that provides various information to users at airports, subways, bus terminals, or the like, a serving robot that can serve various items to guests at restaurants, hotels, or the like, a delivery robot that can transport items such as food, medicine, and delivery items (hereinafter referred to as “items”), or an industrial robot that transports a cart loaded with parts to a destination at a factory, or the like.

According to various embodiments, a robot includes devices that are used for specific purposes (cleaning, ensuring security, monitoring, guiding and the like) or that moves to offer functions according to features of a space in which the robot is moving. Accordingly, devices that have transportation means capable of moving using predetermined information and sensors, and that offer predetermined functions are generally referred to as a robot.

A robot may move with a map stored in it. The map denotes information on fixed objects such as fixed walls, fixed stairs and the like that do not move in a space. Additionally, information on movable obstacles that are disposed periodically, i.e., information on dynamic objects may be stored on the map.

As an example, information on obstacles disposed within a certain range with respect to a direction in which the robot moves forward may also be stored in the map. In this case, unlike the map in which the above-described fixed objects are stored, the map includes information on obstacles, which is registered temporarily, and then removes the information after the robot moves.

Further, the robot may confirm an external dynamic object using various sensors. When the robot moves to a destination in an environment that is crowded with a large number of pedestrians after confirming the external dynamic object, the robot may confirm a state in which waypoints to the destination are occupied by obstacles.

Furthermore, the robot may determine that it arrives at a waypoint on the basis of a degree in a change of directions of the waypoint. The robot then moves to the next waypoint, and, accordingly, the robot can move to a destination successfully.

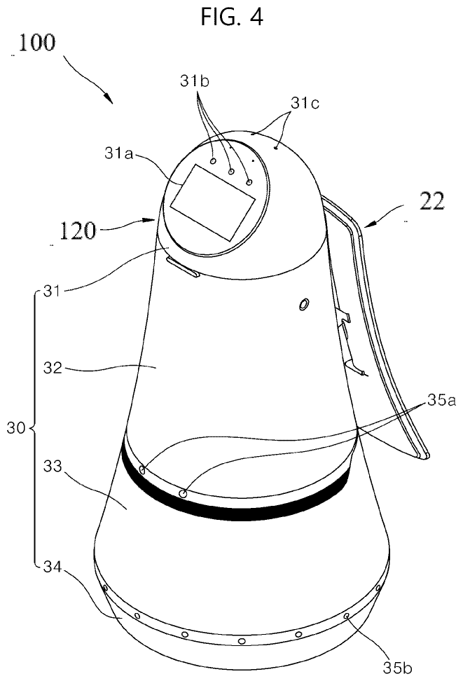

FIG. 4 illustrates a perspective view of a robot 100 according to at least one embodiment. FIG. 4 shows an exemplary appearance. It is understood that the robot may be implemented as robots having various appearances in addition to the appearance of FIG. 4. Specifically, each component may be disposed in different positions in the upward, downward, leftward and rightward directions on the basis of the shape of a robot.

A main body 120 may be configured to be long in the up-down direction, and may have the shape of a roly poly toy that gradually becomes slimmer from the lower portion toward the upper portion, as a whole.

The main body 120 may include a case 30 that forms the appearance of the robot 100. The case 30 may include a top cover 31 disposed on the upper side, a first middle cover 32 disposed on the lower side of the top cover 31, a second middle cover 33 disposed on the lower side of the first middle cover 32, and a bottom cover 34 disposed on the lower side of the second middle cover 33. The first middle cover 32 and the second middle cover 33 may constitute a single middle cover.

The top cover 31 may be disposed at the uppermost end of the robot 100, and may have the shape of a hemisphere or a dome. The top cover 31 may be disposed at a height below the average height for adults to readily receive an instruction from a user. Additionally, the top cover 31 may be configured to rotate at a predetermined angle.

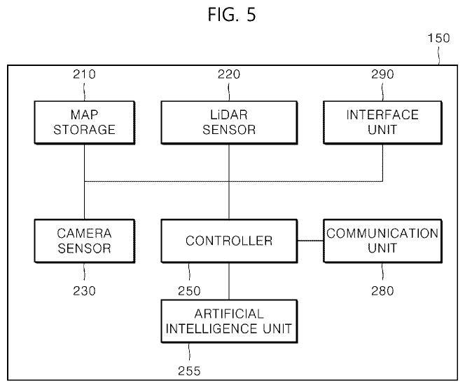

The robot 100 may further include a control module 150 therein (see, e.g., FIG. 5). The control module 150 controls the robot 100 like a type of computer or a type of processor. Accordingly, the control module 150 may be disposed in the robot 100, may perform functions similar to those of a main processor, and may interact with a user.

The control module 150 is disposed in the robot 100 to control the robot during the robot's movement by sensing objects around the robot. The control module 150 of the robot may be implemented as a software module, a chip in which a software module is implemented as hardware, and the like.

A display unit 31a that receives an instruction from a user or that outputs information, and sensors, for example, a camera 31b and a microphone 31c may be disposed on one side of the front surface of the top cover 31.

In addition to the display unit 31a of the top cover 31, a display unit 22 is also disposed on one side of the middle cover 32.

Information may be output by all the two display units 31a, 22 or may be output by any one of the two display units 31a, 22 according to functions of the robot.

Additionally, various obstacle sensors (e.g., sensor 220 of FIG. 5) are disposed on one lateral surface or in the entire lower end portion of the robot 100 like 35a, 35b. As an example, the obstacle sensors include a time-of-flight (TOF) sensor, an ultrasonic sensor, an infrared sensor, a depth sensor, a laser sensor, a LiDAR sensor and the like. The sensors sense an obstacle outside of the robot 100 in various ways.

Additionally, the robot 100 further includes a moving unit that is a component moving the robot in the lower end portion of the robot. The moving unit is a component that moves the robot, like wheels.

The shape of the robot in FIG. 4 is provided as an example. Embodiments of the present disclosure are not limited to the illustrated example. Additionally, various cameras and sensors of the robot may also be disposed in various portions of the robot 100. As an example, the robot 100 may be a guide robot that gives information to a user and moves to a specific spot to guide a user.

The robot 100 may also include a robot that offers cleaning services, security services or functions. The robot 100 may perform a variety of functions.

In a state in which a plurality of robots 100 are disposed in a service space, the robots may perform specific functions (guide services, cleaning services, security services and the like). In such a process, the robot 100 may store information on its position, may confirm its current position in the entire space, and may generate a path required for moving to a destination.

FIG. 5 is a block diagram of a control module 150 of the robot 100 according to at least one embodiment.

The robot 100 may perform both of the functions of generating a map and estimating a position of the robot using the map.

Alternately, the robot 100 may only offer the function of generating a map.

Alternately, the robot 100 may only offer the function of estimating a position of the robot using the map. According to various embodiments, the robot 100 offers the function of estimating a position of the robot using the map. Additionally, the robot 100 may offer the function of generating a map or modifying a map.

A LiDAR sensor 220 may sense surrounding objects two-dimensionally or three-dimensionally. A two-dimensional LiDAR sensor may sense positions of objects within 360-degree ranges with respect to the robot 100. LiDAR information sensed in a specific position may constitute a single LiDAR frame. That is, the LiDAR sensor 220 senses a distance between an object disposed outside the robot 100 and the robot to generate a LiDAR frame.

As an example, a camera sensor 230 is a regular camera. To overcome viewing angle limitations, two or more camera sensors 230 may be used. An image captured in a specific position constitutes vision information. That is, the camera sensor 230 photographs an object outside the robot 100 and generates a visual frame including vision information.

According to various embodiment, the robot 100 performs fusion-simultaneous localization and mapping (Fusion-SLAM) using the LiDAR sensor 220 and the camera sensor 230.

In fusion SLAM, LiDAR information and vision information may be combinedly used. The LiDAR information and vision information may be configured as maps.

Unlike a robot that uses a single sensor (LiDAR-only SLAM, visual-only SLAM), a robot that uses fusion-SLAM may enhance accuracy of estimating a position. That is, when fusion SLAM is performed by combining the LiDAR information and vision information, map quality may be enhanced.

The map quality is a criterion applied to both of the vision map comprised of pieces of vision information, and the LiDAR map comprised of pieces of LiDAR information. At the time of fusion SLAM, map quality of each of the vision map and LiDAR map is enhanced because sensors may share information that is not sufficiently acquired by each of the sensors.

Additionally, LiDAR information or vision information may be extracted from a single map and may be used. For example, LiDAR information or vision information, or all the LiDAR information and vision information may be used for localization of the robot in accordance with an amount of memory held by the robot 100 or a calculation capability of a calculation processor, and the like.

An interface unit 290 receives information input by a user. The interface unit 290 receives various pieces of information such as a touch, a voice and the like input by the user, and outputs results of the input. Additionally, the interface unit 290 may output a map stored by the robot 100 or may output a course in which the robot 100 moves by overlapping on the map.

Further, the interface unit 290 may supply predetermined information to a user.

A controller 250 generates a map, and, on the basis of the map, estimates a position of the robot 100 in the process in which the robot moves.

A communication unit 280 may allow the robot 100 to communicate with another robot or an external server and to receive and transmit information.

The robot 100 may generate each map using each of the sensors (a LiDAR sensor and a camera sensor), or may generate a single map using each of the sensors and then may generate another map in which details corresponding to a specific sensor are only extracted from the single map.

Additionally, the map may include odometry information on the basis of rotations of wheels. The odometry information is information on distances moved by the robot 100, which are calculated using frequencies of rotations of a wheel of the robot, or a difference in frequencies of rotations of both wheels of the robot, and the like. The robot 100 may calculate a distance moved by the robot on the basis of the odometry information as well as the information generated using the sensors.

The controller 250 may further include an artificial intelligence unit 255 for artificial intelligence work and processing.

A plurality of LiDAR sensors 220 and camera sensors 230 may be disposed outside of the robot 100 to identify external objects.

In addition to the LiDAR sensor 220 and camera sensor 230, various types of sensors (a LiDAR sensor, an infrared sensor, an ultrasonic sensor, a depth sensor, an image sensor, a microphone, and the like) are disposed outside of the robot 100. The controller 250 collects and processes information sensed by the sensors.

The artificial intelligence unit 255 may input information that is processed by the LiDAR sensor 220, the camera sensor 230 and the other sensors, or information that is accumulated and stored while the robot 100 is moving, and the like, and may output results required for the controller 250 to determine an external situation, to process information and to generate a moving path.

As an example, the robot 100 may store information on positions of various objects, disposed in a space in which the robot is moving, as a map. The objects may include a fixed object such as a wall, a door and the like, and a movable object such as a flower pot, a desk and the like. The artificial intelligence unit 255 may output data on a path taken by the robot 100, a range of work covered by the robot, and the like, using map information and information supplied by the LiDAR sensor 220, the camera sensor 230 and the other sensors.

Additionally, the artificial intelligence unit 255 may recognize objects disposed around the robot 100 using information supplied by the LiDAR sensor 220, the camera sensor 230 and the other sensors. The artificial intelligence unit 255 may output meta information on an image by receiving the image. The meta information includes information on the name of an object in an image, a distance between an object and the robot, the sort of an object, whether an object is disposed on a map, and the like.

Information supplied by the LiDAR sensor 220, the camera sensor 230 and the other sensors is input to an input node of a deep learning network of the artificial intelligence unit 255, and then results are output from an output node of the artificial intelligence unit 255 through information processing of a hidden layer of the deep learning network of the artificial intelligence unit 255.

The controller 250 may calculate a moving path of the robot using date calculated by the artificial intelligence unit 255 or using data processed by various sensors.

As noted earlier, robots equipped with 2D LiDARs (but not 3D LiDARs) rely on accurate 2D maps. Such 2D maps may be generated based on indoor 3D point clouds. Some approaches use random sample consensus (RANSAC) to fit plane candidates within a 3D point cloud. However, the results are susceptible to planar artifacts, and essential 2D features that are required for navigation may be lost. Also, such approaches require input of clean, noise-free point 3D clouds.

Some approaches introduced deep learning techniques for generating 2D floor plans. These approaches employ specialized end-to-end networks that convert point cloud data into 2D floor plans. Additionally, some studies have proposed growing-based approaches that construct global building layouts from noisy stereo camera point clouds.

However, the above approaches and proposals are not directed to generating 2D maps for robot navigation, based on 3D point clouds representing environments that are affected by camera noise. Also, the above approaches and proposals are not directed to generating 2D maps while accounting for the presence of unwanted objects in the 3D point clouds.

Aspects of this disclosure are directed to a method and apparatus for generating 2D navigation maps for robotics applications from noisy indoor point clouds. According to one or more aspects, deep learning-based classification techniques are used to perform both 3D and 2D object detection. Unwanted objects are autonomously identified and filtered from the navigation maps, resulting in cleaner and more reliable 2D maps suitable for robotic navigation.

As will be described with reference to various embodiments, noise from 3D sensor data is effectively filtered noise while preserving critical geometric features such as corners and fine details. This capability is particularly beneficial when processing noisy point clouds generated by stereo cameras. Also, deep learning-based classification is employed to accurately detect and remove unwanted objects from the point cloud, including pedestrians, chairs, and moving carts. Additionally, by slicing the 3D point cloud at a height corresponding to the robot's sensor plane, the resulting 2D map better aligns with the 2D scan data, thereby enhancing navigation accuracy for specific classes of ground-based robots.

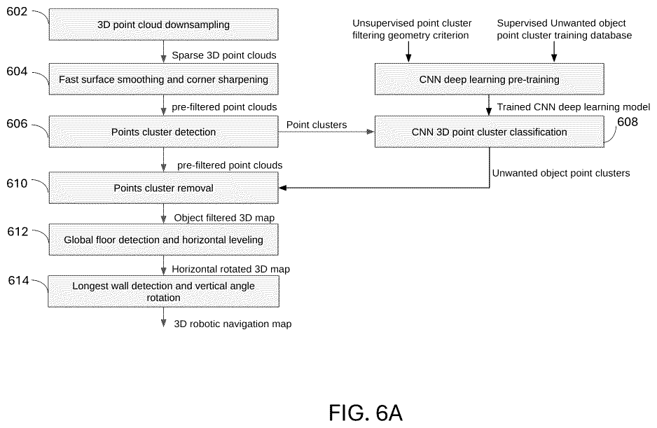

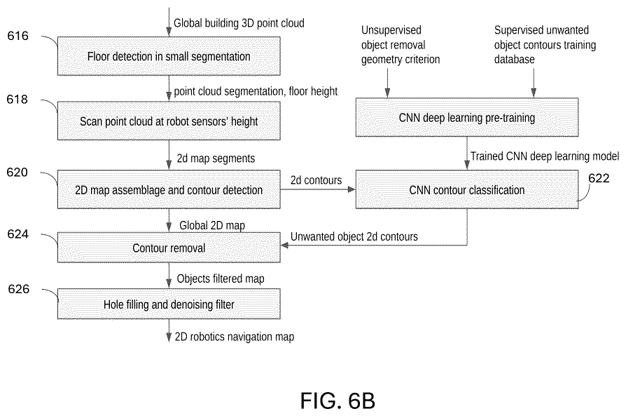

FIGS. 6A and 6B illustrate a flowchart for generating a global 2D map of an indoor environment based on 3D data according to at least one embodiment. Processing of a 3D point cloud will first be described with reference to FIG. 6A.

At block 602, an indoor point cloud is downsampled to simplify data and reduce computation complexity. The downsampling may involve removing redundant points in the data set, in order to reduce the size of the data set. By way of example, the downsampling may include voxel downsampling, during which points in a 3D grid (or voxel) are replaced by a fewer number of point (e.g., a single point).

As illustrated in FIG. 6A, the downsampling produces a sparse 3D point cloud.

At block 604, the sparse 3D point cloud is input to a filter that is configured to smoothen representations of flat surfaces in the indoor environment and/or sharpen representations of corners (or edges) of the indoor environment. Examples of such flat surfaces may include furniture surfaces (e.g., a face of a table), floor and walls. For example, although the upper surface of a table in the indoor environment is flat, the representation of this surface in the point cloud may not be similarly flat due to camera noise and other factors. The filtering of block 604 serves to smoothen the representation of the surface in order to improve the accuracy of the representation.

Examples of corners may include corners at which two walls meet each other. Although the two walls meet to form a perfect right angle therebetween, the representation of the angle in the point cloud may not be similarly perfect due to camera noise and other factors. The filtering of block 604 serves to sharpen the representation of the corner in order to improve the accuracy of the representation.

Similarly, examples of edges may include edges at which two walls meet each other. Although the two walls meet to form a clean edge therebetween, the representation of the edge in the point cloud may not be similarly perfect due to camera noise and other factors. The filtering of block 604 serves to sharpen the representation of the edge in order to improve the accuracy of the representation.

As such, the filter of block 604 not only removes sensor noise but also enhances the geometric quality of the resulting map.

As illustrated in FIG. 6A, the filtering produces a pre-filtered point cloud.

At block 606, the pre-filtered point cloud is input to a detector (e.g., point clustering algorithm) that detects one or more point clusters that are present in the point cloud. The detector may detect a group of spatially related points as a point cluster. Detected clusters are input to a CNN-based classifier (e.g., CNN 3D point cluster classification filter) 608.

The CNN-based classifier 608 utilizes a deep learning model to classify each of the clusters. The deep learning model has been trained to classify a cluster as belonging to a particular object (or particular class of objects). The training may involve unsupervised learning (with regards to classification based on geometric criteria) and also supervised learning (with regards to point clusters corresponding to objects that are unwanted).

Based on outputs of the model, the CNN-based classifier 608 classifies each of the clusters as belonging to a particular object. The CNN-based classifier 608 may also identify one or more clusters as corresponding to an object(s) that is unwanted. By way of example, objects (or classes of objects) that are unwanted for a given use case may include particular items of furniture and/or dynamic (or non-stationary) objects such as human beings.

As will be described in more detail below, such classification and identification result in a 3D map that is cleaner and also object-filtered.

At block 610, information regarding the clusters identified as corresponding to unwanted objects is provided. Based on such information, the point clusters corresponding to the unwanted objects are removed from the pre-filtered point cloud. Such removal results in an object-filtered 3D map.

According to various embodiments, removal of point clusters corresponding to particular objects during processing of 3D point clouds is preferable to such removal during processing of 2D point clouds. For such objects, classification of the point cluster can be more accurate when based on 3D data. For example, when the object is a human being, 3D data can allow for the point cluster to be classified as such, more readily. Because 2D data inherently contains less information, such classification may be less accurate.

At block 612, global floor detection is performed based on the object-filtered 3D map. The detection identifies a global floor (or global floor plane) within the 3D map. The map is then rotated such that the identified floor plane is aligned to a reference plane that is fully horizontal (e.g., x-y plane), in order to standardize orientation.

In at least some situations, the 3D map may capture an indoor environment that has multiple floor surfaces that are not necessarily level with each other. For example, an indoor shopping mall may have floor surfaces in various areas (or sections or rooms) that are not level with each other. In such situations, identifying the global floor standardizes orientation.

At block 614, the longest wall that is depicted in the 3D map is identified. Accordingly, the horizontally-rotated 3D map of block 612 is rotated (e.g., about a vertical axis) to ensure a consistent and horizontally aligned map orientation.

After the horizontal leveling of block 612, it is possible that the longest wall may be depicted in a manner that is less than optimal with respect to the horizontal plane (e.g., x-y plane). When depicted in such a manner, the 3D map may appear less appealing to human eyes. Therefore, at block 614, the map is rotated about a vertical axis (e.g., z-axis). To aid readability, the map is rotated such that the longest wall extends to be aligned visually with the horizontal plane.

With reference to FIG. 6A, generation of a 3D robotic navigation map has been described. The 3D robotic navigation map corresponds to a global 3D point cloud that was captured to represent an indoor environment.

Processing of the 3D robotic navigation map to produce a 2D map will be described in more detail with reference to FIG. 6B. As will be described, the 2D map is configured to be for use by a specific robot(s).

At block 616, the 3D robotic navigation map is divided into smaller segments. For example, each of such segments may correspond to a different room or distinct area. As another example, each segment may correspond not necessarily to a distinct room, but rather an area having specific dimensions (e.g., an area of 5 square meters relative to the x-y plane).

For each segment, processing will be performed. The processing will be described with reference to blocks 616 and 618.

With continued reference to block 616, local floor detection is performed to establish a reference plane for the segment. The floor detection may have similarity to the global floor detection described earlier with reference to block 612 of FIG. 6A. Here, it is recognized that the segment may have a height that is different from the heights of other segments. Therefore, the floor that is specific to the segment is detected.

At block 618, the segment is scanned at one or more heights relative to the detected floor. Each height corresponds to a sensor (e.g., 2D LiDAR sensor) of the robot for which the 2D map is configured.

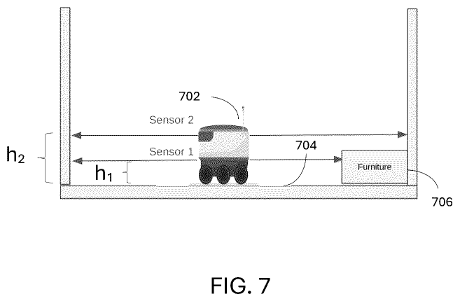

For example, FIG. 7 illustrates an environmental diagram of a robot 702 while in operation in an indoor environment. The robot 702 has two sensors. A first sensor of the robot 702 (“Sensor 1”) is located at a height h₁ relative to a floor 704. A second sensor of the robot 702 (“Sensor 2”) is located at a height h₂ relative to the floor 704. Although FIG. 7 illustrates the robot 702 as having two sensors by way of example, it is understood that the robot may have only one sensor (e.g., “Sensor 1” or “Sensor 2”) and not both sensors.

Returning to FIG. 6B, at block 618, the segment is scanned at the height h₁ to produce a first localized 2D map segment. The first localized 2D map segment may be considered as being a “slice” of the 3D map segment that is isolated from the 3D map segment at the height h₁. In essence, the first localized 2D map segment captures only those objects that would be observed by the first sensor (“Sensor 1”). For example, the first localized 2D map segment would capture the furniture 706. As such, scanning at the actual height of the first sensor ensures that the first localized 2D map segment aligns with data captured by the first sensor, thereby enhancing navigation accuracy.

Similarly, the segment is scanned at the height h₂ to produce a second localized 2D map segment. The second localized 2D map segment captures only those objects that would be observed by the second sensor (“Sensor 2”). For example, unlike the first localized 2D map segment, the second localized 2D map segment would not capture the furniture 706, due to the height h₂ being greater than the height of the furniture 706.

In this regards, it is noted that scanning at different sensor heights (e.g., h₁, h₂) may yield different room widths due, e.g., to the presence of furniture such as furniture 706.

At block 620, individual 2D map segments are assembled to form a complete global 2D map. For example, for the robot 702 of FIG. 7, a pair of localized 2D map segments may be produced for each smaller segment of the 3D robotic navigation map (see block 616). In this situation, the pairs of localized 2D map segments are merged to produce a global 2D map.

To refine the map further, 2D contour detection is performed. The global 2D map is input to a detector (e.g., contour detection algorithm) that detects one or more contours that are present in the global 2D map. The detector may detect a group of spatially related points as a contour. Detected clusters are input to a CNN-based classifier (e.g., CNN contour classification filter) 622.

The operation of the CNN contour classification filter 622 is similar to that of the CNN 3D point cluster classification filter 608, which was described earlier with reference to FIG. 6A. For purposes of brevity, the similarities will not be described in detail below. However, select differences will be described.

Instead of 3D point clusters, the CNN contour classification filter 622 operates on 2D contours. Accordingly, the speed at which the CNN contour classification filter 622 classifies contours and removes certain contours that correspond to unwanted objects is significantly faster relative to the CNN 3D point cluster classification filter 608. However, as noted earlier with reference to FIG. 6A, because 2D data inherently contains less information, the classification of the contours may be less accurate than the classification of the 3D point clusters.

A contour that is identified as corresponding to an unwanted object may correspond to a 2D projection that “remains” after a corresponding 3D point cluster was removed earlier (see block 610 of FIG. 6A).

At block 624, information regarding the classified contours and information regarding the contours corresponding to unwanted objects are provided. Based on such information, the contours corresponding to unwanted objects are removed from the global 2D map. Examples of contours that may be unwanted include contours corresponding to outlines of furniture or temporary obstructions. Such removal results in an objects-filtered 2D map (or contour-filtered 2D map).

At block 626, the objects-filtered 2D map is input to a hole-filling and denoising filter to further enhance map completeness and clarity. Here, holes that are filled may be relatively small holes that are considered as noise. Such noise may have also resulted from earlier removal of a 3D point cluster. Such holes may be filled using interpolation algorithms that, for example, generate new points by analyzing the local geometry of surrounding points.

Accordingly, a clean and accurate 2D navigation map suitable for robotic operations is produced. The 2D robotic navigation map represent the global 3D point cloud of the indoor environment.

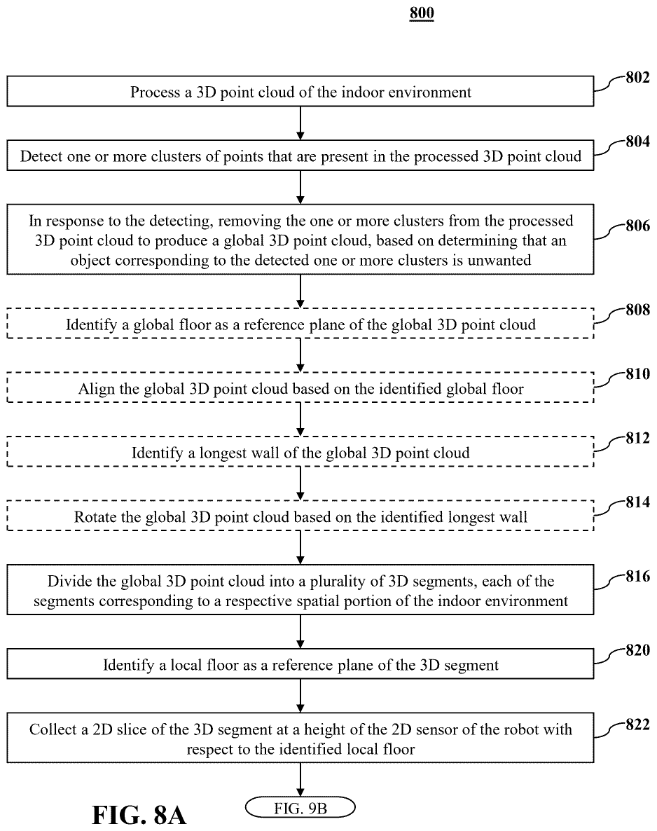

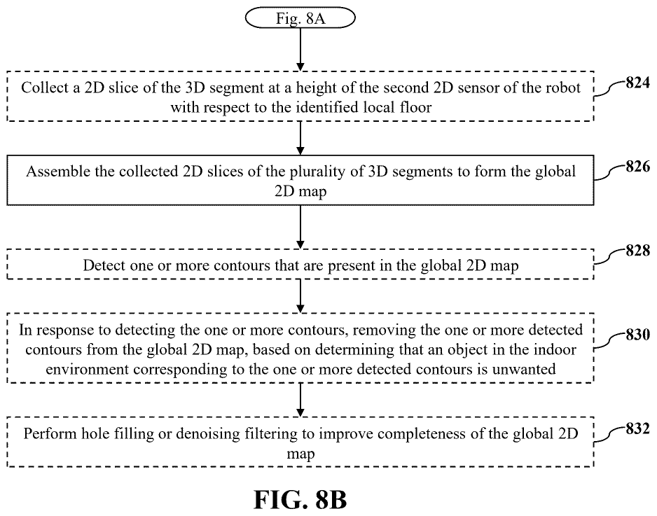

FIGS. 8A and 8B illustrates a flowchart of a method 800 of training a neural network for mapping an indoor environment according to at least one embodiment.

At block 802, a 3D point cloud of the indoor environment is processed. (See, e.g., block 604 of FIG. 6A.) The 3D point cloud may have been generated by at least 3D LiDAR, one or more RGB-D cameras, one or more time-of-flight (TOF) cameras, or one or more stereo cameras.

According to a further embodiment, processing the 3D point cloud enhances one or more geometric features of the indoor environment. Processing the 3D point cloud may enhance the one or more geometric features by surface smoothening a wall or a floor of the indoor environment, or sharpening a corner or an edge of a space of the indoor environment.

At block 804, one or more clusters of points that are present in the processed 3D point cloud are detected.

For example, as described earlier with reference to block 606 of FIG. 6A, a pre-filtered point cloud is input to a detector (e.g., point clustering algorithm) that detects one or more point clusters that are present in the point cloud. The detector may detect a group of spatially related points as a point cluster.

At block 806, in response to the detecting, the one or more clusters are removed from the processed 3D point cloud to produce a global 3D point cloud, based on determining that an object corresponding to the detected one or more clusters is unwanted.

For example, as described earlier with reference to block 610 of FIG. 6A, information regarding clusters identified as corresponding to unwanted objects is provided. Based on such information, the point clusters corresponding to the unwanted objects are removed from the pre-filtered point cloud.

At block 808, a global floor may be identified as a reference plane of the global 3D point cloud.

At block 810, the global 3D point cloud may be aligned based on the identified global floor.

For example, as described earlier with reference to block 612 of FIG. 6A, global floor detection is performed based on the object-filtered 3D map. The detection identifies a global floor (or global floor plane) within the 3D map. The map is then rotated such that the identified floor plane is aligned to a reference plane that is fully horizontal (e.g., x-y plane), in order to standardize orientation.

At block 812, a longest wall of the global 3D point cloud may be identified.

At block 814, the global 3D point cloud may be rotated based on the identified longest wall.

For example, as described earlier with reference to block 614 of FIG. 6A, the longest wall that is depicted in the 3D map is identified. Accordingly, the horizontally-rotated 3D map of block 612 is rotated (e.g., about a vertical axis such as the z-ax0s) to ensure a consistent and horizontally aligned map orientation.

At block 816, the global 3D point cloud is divided into a plurality of 3D segments. Each of the segments corresponds to a respective spatial portion of the indoor environment.

At block 820, for each of the plurality of 3D segments, a local floor is identified as a reference plane of the 3D segment.

For example, as described earlier with reference to block 616 of FIG. 6B, the 3D robotic navigation map is divided into smaller segments. For example, each of such segments may correspond to a different room or distinct area. As another example, each segment may correspond not necessarily to a distinct room, but rather an area having specific dimensions (e.g., an area of 5 square meters relative to the x-y plane).

As also described earlier with reference to block 616 of FIG. 6B, local floor detection is performed to establish a reference plane for the segment. The segment may have a height that is different from the heights of other segments. Therefore, the floor that is specific to the segment is detected.

At block 822, a 2D slice of the 3D segment at a height of the 2D sensor of the robot with respect to the identified local floor is collected.

For example, as described earlier with reference to block 618 of FIG. 6B, the segment is scanned at one or more heights relative to the detected floor. Each height corresponds to a sensor (e.g., 2D LiDAR sensor) of the robot for which the 2D map is configured. For example, a 2D slice of the 3D segment at a height of “Sensor 1” of the robot 702 of FIG. 7 is collected.

According to a further embodiment, the robot further includes a second 2D sensor.

At block 824, a 2D slice of the 3D segment at a height of the second 2D sensor of the robot with respect to the identified local floor may be collected.

For example, as described earlier with reference to block 618 of FIG. 6B, a 2D slice of the 3D segment at a height of “Sensor 2” of the robot 702 of FIG. 7 is collected.

At block 826, the collected 2D slices of the plurality of 3D segments are assembled to form the global 2D map.

For example, the collected 2D slices of the plurality of 3D segments at the height of the 2D sensor and the collected 2D slices of the plurality of 3D segments at the height of the second 2D sensor may be assembled to form the global 2D map.

For example, as described earlier with reference to block 620 of FIG. 6B, individual 2D map segments are assembled to form a complete global 2D map. For example, for the robot 702 of FIG. 7, a pair of localized 2D map segments may be produced for each smaller segment of the 3D robotic navigation map (see block 616 of FIG. 6B). In this situation, the pairs of localized 2D map segments are merged to produce a global 2D map.

At block 828, one or more contours that are present in the global 2D map may be detected.

For example, as also described earlier with reference to block 620 of FIG. 6B, the global 2D map is input to a detector (e.g., contour detection algorithm) that detects one or more contours that are present in the global 2D map. The detector may detect a group of spatially related points as a contour. Detected clusters are input to a CNN-based classifier (e.g., CNN contour classification filter) 622.

At block 830, the one or more detected contours may be removed from the global 2D map, based on determining that an object in the indoor environment corresponding to the one or more detected contours is unwanted.

For example, as described earlier with reference to block 624 of FIG. 6B, information regarding the classified contours and information regarding the contours corresponding to unwanted objects are provided. Based on such information, the contours corresponding to unwanted objects are removed from the global 2D map. Examples of contours that may be unwanted include contours corresponding to outlines of furniture or temporary obstructions.

At block 832, hole filling or denoising filtering may be performed to improve completeness of the global 2D map.

For example, as described earlier with reference to block 626 of FIG. 6B, the objects-filtered 2D map is input to a hole-filling and denoising filter to further enhance map completeness and clarity. Here, holes that are filled may be relatively small holes that are considered as noise. Such noise may have also resulted from earlier removal of a 3D point cluster. Such holes may be filled using interpolation algorithms that, for example, generate new points by analyzing the local geometry of surrounding points.

Aspects and features described herein with reference to various embodiments are directed towards generating maps of indoor environments to support autonomous robot navigation. Such aspects and features may enhance the quality, reliability, and efficiency of map generation. Resulting maps can be used to guide robotic navigation for a variety of applications, including but not limited to autonomous vacuum cleaning, food and service delivery, tourist assistance, and automated roaming tasks.

The above-described embodiments are combinations of the components and features of the disclosure in specific forms. Each component or feature should be considered optional unless explicitly mentioned otherwise. Each component or feature may be implemented without being combined with other elements or features. Furthermore, some components and/or features may be combined to implement embodiments of the disclosure. The order of operations described in the embodiments of the disclosure may be rearranged. Some components or features of one embodiment may be included in another embodiment, or the components or features may be replaced with related components or features of the other embodiment. It is obvious that claims that are not explicitly cited in the appended claims may be combined to form an embodiment or included as a new claim by amendment after filing.

It is evident to those skilled in the art that the disclosure could be realized in various specific forms within the scope of the features of the disclosure. Therefore, the detailed description above should not be interpreted restrictively in all respects but should be considered as illustrative. The scope of the disclosure should be determined by a reasonable interpretation of the appended claims, and all changes within the equivalent scope of the disclosure are encompassed within the scope of the disclosure.

What is claimed is:

1. A computer-implemented method of generating a global two-dimensional (2D) map of an indoor environment based on three-dimensional (3D) data, the 2D map for guiding autonomous navigation of a robot comprising a 2D sensor, the computer-implemented method comprising:
processing a 3D point cloud of the indoor environment;
detecting one or more clusters of points that are present in the processed 3D point cloud;
in response to the detecting, removing the one or more clusters from the processed 3D point cloud to produce a global 3D point cloud, based on determining that an object corresponding to the detected one or more clusters is unwanted;
dividing the global 3D point cloud into a plurality of 3D segments, each of the segments corresponding to a respective spatial portion of the indoor environment;
for each of the plurality of 3D segments:
identifying a local floor as a reference plane of the 3D segment; and
collecting a 2D slice of the 3D segment at a height of the 2D sensor of the robot with respect to the identified local floor; and
assembling the collected 2D slices of the plurality of 3D segments to form the global 2D map.

2. The computer-implemented method of claim 1, wherein the 3D point cloud is generated by at least 3D LiDAR, one or more RGB-D cameras, one or more time-of-flight (TOF) cameras, or one or more stereo cameras.

3. The computer-implemented method of claim 1, wherein processing the 3D point cloud enhances one or more geometric features of the indoor environment.

4. The computer-implemented method of claim 3, wherein processing the 3D point cloud enhances the one or more geometric features by surface smoothening a wall or a floor of the indoor environment, or sharpening a corner or an edge of a space of the indoor environment.

5. The computer-implemented method of claim 1, further comprising:
identifying a global floor as a reference plane of the global 3D point cloud; and
aligning the global 3D point cloud based on the identified global floor.

6. The computer-implemented method of claim 1, further comprising:
identifying a longest wall of the global 3D point cloud; and
rotating the global 3D point cloud based on the identified longest wall.

7. The computer-implemented method of claim 1,
wherein the robot further comprises a second 2D sensor, and
wherein the computer-implemented method further comprises:
for each of the plurality of 3D segments:
collecting a 2D slice of the 3D segment at a height of the second 2D sensor of the robot with respect to the identified local floor,
wherein the collected 2D slices of the plurality of 3D segments at the height of the 2D sensor and the collected 2D slices of the plurality of 3D segments at the height of the second 2D sensor are assembled to form the global 2D map.

8. The computer-implemented method of claim 1, further comprising:
detecting one or more contours that are present in the global 2D map; and
in response to detecting the one or more contours, removing the one or more detected contours from the global 2D map, based on determining that an object in the indoor environment corresponding to the one or more detected contours is unwanted. performing hole filling or denoising filtering to improve completeness of the global 2D map.

10. The computer-implemented method of claim 1,
wherein the global 2D map is configured for guiding autonomous navigation of the robot to perform at least vacuum cleaning, food or service delivery, tour guidance or autonomous roaming.

11. An artificial intelligence (AI) device configured to generate a global two-dimensional (2D) map of an indoor environment based on three-dimensional (3D) data, the 2D map for guiding autonomous navigation of a robot comprising a 2D sensor, the AI device comprising:
at least one transceiver; and
at least one processor configured to:
process a 3D point cloud of the indoor environment;
detect one or more clusters of points that are present in the processed 3D point cloud;
in response to the detecting, remove the one or more clusters from the processed 3D point cloud to produce a global 3D point cloud, based on determining that an object corresponding to the detected one or more clusters is unwanted;
divide the global 3D point cloud into a plurality of 3D segments, each of the segments corresponding to a respective spatial portion of the indoor environment;
for each of the plurality of 3D segments:
identify a local floor as a reference plane of the 3D segment; and
collect a 2D slice of the 3D segment at a height of the 2D sensor of the robot with respect to the identified local floor; and
assemble the collected 2D slices of the plurality of 3D segments to form the global 2D map.

12. The AI device of claim 11, wherein the 3D point cloud is generated by at least 3D LiDAR, one or more RGB-D cameras, one or more time-of-flight (TOF) cameras, or one or more stereo cameras.

13. The AI device of claim 11, wherein processing the 3D point cloud enhances one or more geometric features of the indoor environment.

14. The AI device of claim 13, wherein processing the 3D point cloud enhances the one or more geometric features by surface smoothening a wall or a floor of the indoor environment, or sharpening a corner or an edge of a space of the indoor environment.

15. The AI device of claim 11, wherein the at least one processor is further configured to:
identify a global floor as a reference plane of the global 3D point cloud; and
align the global 3D point cloud based on the identified global floor.

16. The AI device of claim 11, wherein the at least one processor is further configured to:
identify a longest wall of the global 3D point cloud; and
rotate the global 3D point cloud based on the identified longest wall.

17. The AI device of claim 11,
wherein the robot further comprises a second 2D sensor, and
wherein the at least one processor is further configured to:
for each of the plurality of 3D segments:
collect a 2D slice of the 3D segment at a height of the second 2D sensor of the robot with respect to the identified local floor,
wherein the collected 2D slices of the plurality of 3D segments at the height of the 2D sensor and the collected 2D slices of the plurality of 3D segments at the height of the second 2D sensor are assembled to form the global 2D map.

18. The AI device of claim 11, wherein the at least one processor is further configured to:
detect one or more contours that are present in the global 2D map; and
in response to detecting the one or more contours, remove the one or more detected contours from the global 2D map, based on determining that an object in the indoor environment corresponding to the one or more detected contours is unwanted.

19. The AI device of claim 11, wherein the at least one processor is further configured to:
perform hole filling or denoising filtering to improve completeness of the global 2D map.

20. A non-transitory storage medium storing instructions that, when executed, cause at least one processor to perform operations, the operations comprising
processing a three-dimensional (3D) point cloud of an indoor environment;
detecting one or more clusters of points that are present in the processed 3D point cloud;
in response to the detecting, removing the one or more clusters from the processed 3D point cloud to produce a global 3D point cloud, based on determining that an object corresponding to the detected one or more clusters is unwanted;
dividing the global 3D point cloud into a plurality of 3D segments, each of the segments corresponding to a respective spatial portion of the indoor environment;
for each of the plurality of 3D segments:
identifying a local floor as a reference plane of the 3D segment; and
collecting a two-dimensional (2D) slice of the 3D segment at a height of a 2D sensor of a robot with respect to the identified local floor; and
assembling the collected 2D slices of the plurality of 3D segments to form a global 2D map for guiding autonomous navigation of the robot.
